(19) United States
(12) Patent Application Publication
(10) Pub. No.: US 2004/0080505 A1
(43) Pub. Date: Apr. 29, 2004

(54) Moving picture file distributing device

(75) Inventors: Satoshi Miyaji, Saitama (JP); Yasuhiro Takishima, Saitama (JP); Masahiro Wada, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 10/686,710

(22) Filed: Oct. 17, 2003

(30) Foreign Application Priority Data
Oct. 21, 2002 (JP) 2002-306195

(51) Int. Cl. G06F 17/00

(52) U.S. Cl. 345/418

(57) ABSTRACT

To provide a moving picture file distributing device capable of avoiding a failure due to competition between uploading and downloading in a real-time distribution of a moving picture file.

An upload buffer management section (9) generates an upload buffer (61) in a buffer memory (8) in response to an upload request. An upload file is temporarily held in an upload buffer (61), and is transferred to storage means (5) after uploading is completed. A download buffer management section (10) generates a download buffer (71) in the buffer memory (8) in response to a download request. A download file is transferred from the download buffer (71) to a client. The upload buffer (61) or the download buffer (71) after transferred is eliminated.

### BACKGROUND OF THE INVENTION

1. Field of the Invention

The present invention relates to a moving picture file distributing device, particularly to a moving picture file distributing device capable of avoiding a failure due to competition between uploading and downloading in a real-time distribution of a moving picture file.

2. Description of the Related Art

Conventionally, when a moving picture file is downloaded and distributed by HTTP (hypertext transfer protocol), a typical WWW file distributing device (hereinafter, referred to as server) which is not dedicated to moving picture file distribution is generally employed.

FIG. 7 shows a structure of a conventional server. A server 1 comprises a network I/F section 2 connected to a network such as LAN or ADSL, a HTTP server section 3, a file I/O section 4, and storage means 5 such as a hard disk.

When a file provided by a file provider is stored in the server 1, that is, at the time of uploading a file, the HTTP server section 3 immediately transfers an upload file to the storage means 5 via the file I/O section 4 in response to an upload request received via the network I/F section 2, and stores it in a predetermined position (directory). Further, a result indicating that the uploading has been performed successfully or failed is transmitted as a response to the file provider.

When a file is distributed to a receiver (hereinafter, referred to as client), that is, at the time of downloading a file, when a request relating to a download file is transmitted from the client to the server 1, the HTTP server section 3 searches the requested file from the directory, and distributes the file as a response to the client. Error information, such as one occurring when the requested file is not found, is also transmitted as a response.

The conventional server distributes a file already and constantly present in the server in response to a request. But, for example, when the channel speed between the file provider and the server is low, or when the file size is remarkably large even when the channel speed is high to a certain degree, it takes more time to complete to upload an entire file. When a download request is issued from the client for the file during being uploaded under such a situation, competition between file accesses to the storage means occurs, thereby causing a problem such as the denial of a download request as an error or the downloading of the already uploaded part of the file.

Further, when the channel speed between the server and the client is low, or when the file size is remarkably large even when the channel speed is high to a certain degree, it takes more time to download. When an upload (file update) request is issued from the file provider for a file during being downloaded under such a situation, competition between file accesses to the storage means occurs, causing a failure such as the denial of an uploaded request or the interruption of downloading.

In other words, in the conventional server, uploading and downloading are preferably performed on the conditions that uploading by the file provider is not frequently performed, a download request is not issued during uploading or an upload request is not issued during downloading, the sufficiently fast speed (channel) is used for uploading, and a time required for downloading is remarkably short.

Since this condition is maintained such as one occurring when contents of a file to be distributed are not constantly updated and one occurring when an Internet WWW homepage whose. file size is not so large is distributed, a problem does not occur in a typical operation.

However, for example, when a system for HTTP-downloading a live moving picture file is desired to realize, it is required that continuously generated moving picture data is appropriately segmentalized, for example, for a certain time or for a certain data size to be sequentially uploaded as a file in a server, and at the same time, the latest file can be downloaded in response to a distribution request from the client. Further, a size of each segmentalized file is remarkably large as compared with a WWW homepage text or a still image.

In such a system, the preconditions for preferably performing uploading and downloading in the conventional server such as not frequent uploading, not issuance of a download request during uploading or not issuance of an upload request during downloading, and high-speed uploading cannot be maintained. Therefore, when the conventional server is applied to live moving picture file distribution as it is, the phenomena such as the unsuccessful uploading, the corruption of an upload file, the denial of downloading, or the corruption of a downloaded file occur.

Further, when a plurality of clients who request to download the same file are present and distribution requests are performed in a time shifting manner, one file is continuously being accessed for a long time, so that a possibility that an upload request is issued during downloading is greatly increased.

### SUMMARY OF THE INVENTION

It is an object of the present invention to provide a moving picture file distributing device capable of solving the problems of the aforementioned conventional technique, and avoiding a failure due to competition between uploading and downloading in a real-time distribution of a moving picture file.

To attain the above object, in the first aspect of the present invention, it provides a moving picture file distributing device which receives a moving picture file by uploading and stores it in storage means, and distributes the moving picture file stored in the storage means to a client by downloading, the device comprising upload buffer generating means for dynamically generating an upload buffer for temporarily holding a moving picture file at the time of reception for each session, and download buffer generating means for dynamically generating a download buffer for temporarily holding a moving picture file at the time of distribution for each session.

Also, in the second aspect of the present invention, it provides a moving picture file distributing device which receives a moving picture file by uploading and stores it in storage means, and distributes the moving picture file stored in the storage means to a client by downloading, the device comprising means for, after holding an entire moving picture file in the upload buffer is completed, transferring the moving picture file to the storage means, and means for, after an entire moving picture file is transferred to the storage means, eliminating the upload buffer, wherein the upload buffer generating means generates an upload buffer when uploading is started.

Also, in the third aspect of the present invention, it provides a moving picture file distributing device which receives a moving picture file by uploading and stores it in storage means, and distributes the moving picture file stored in the storage means to a client by downloading, the device comprising means for, each time holding fragments in a moving picture file in the upload buffer by one fragment is completed, transferring the fragments to the storage means, and means for, after all fragments in a moving picture file are transferred to the storage means, eliminating the upload buffer, wherein the upload buffer generating means generates an upload buffer when uploading is started.

Also, in the fourth aspect of the present invention, it provides a moving picture file distributing device which receives a moving picture file by uploading and stores it in storage means, and distributes the moving picture file stored in the storage means to a client by downloading, the device comprising means for, at the same time with the generation of the download buffer, transferring a moving picture file to be downloaded from the storage means to the download buffer, and means for, after an entire moving picture file is downloaded, eliminating the download buffer, wherein the download buffer generating means generates a download buffer when downloading is started.

Further, in the fifth aspect of the present invention, it provides a moving picture file distributing device which receives a moving picture file by uploading and stores it in storage means, and distributes the moving picture file stored in the storage means to a client by downloading, the device comprising means for, at the same time with the generation of a download buffer, transferring a moving picture file to be downloaded from the storage means to the download buffer by one fragment, and

means for downloading fragments from the download buffer, and eliminating the download buffer after all fragments in a moving picture file are downloaded, wherein the download buffer generating means generates a download buffer when downloading is started.

According to the characteristics of the present invention, since an upload buffer for temporarily holding an upload file and a download buffer for temporarily holding a download file are dynamically generated, a failure due to competition between uploading and downloading can be avoided, and the dynamic buffer generation can minimize the use of the buffer memory. Furthermore, when a moving picture file has a fragment form, an upload buffer or a download buffer for holding one fragment is generated and processed in units of fragment so that a possibility of the competition between uploading and downloading can be reduced.

### BRIEF DESCRIPTION OF THE DRAWINGS

FIG. 1 is a block configuration diagram showing one embodiment of a moving picture file distributing device according to the present invention;

FIG. 2 is a flow chart showing one example of an operation of an upload buffer management section;

FIG. 3 is a flow chart showing one example of an operation of a download buffer management section;

FIG. 4 is an explanatory diagram showing a structure of a distributed file;

FIG. 5 is a flowchart showing another example of the operation of the upload buffer management section;

FIG. 6 is a flow chart showing another example of the operation of the download buffer management section; and

FIG. 7 is a block configuration diagram showing a structure of a conventional server.

### DETAILED DESCRIPTION OF THE PREFERRED EMBODIMENT

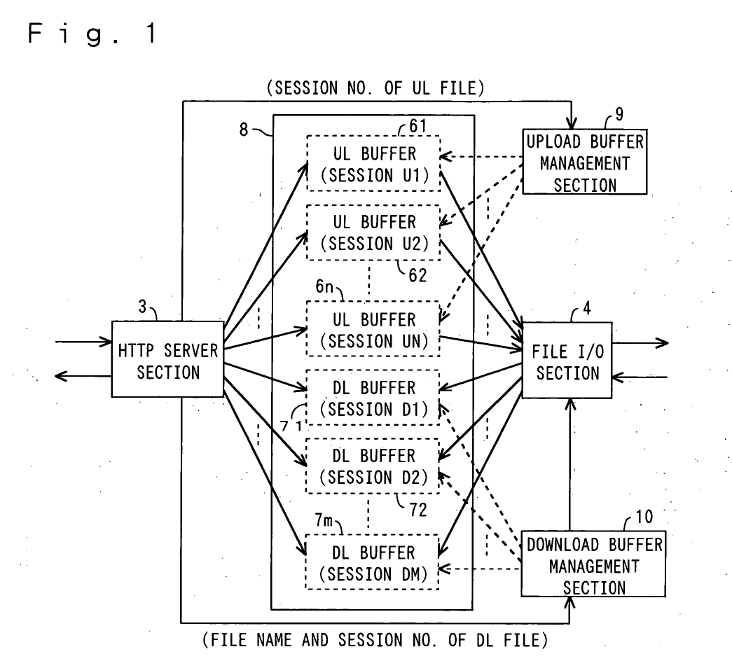

Hereinafter, the present invention will be described in detail with reference to the drawings. FIG. 1 is a block configuration diagram showing one embodiment of a moving picture file distributing device according to the present invention. Like reference characters designate corresponding or similar parts in FIG. 7.

The present embodiment is different from a server in FIG. 7 in that a buffer memory 8 where upload buffers 61 to 6n and download buffers 71 to 7m are dynamically generated is provided between a HTTP server section 3 and a file I/O section 4, an upload buffer management section 9 for generating/managing the upload buffers 61 to 6n is provided, and a download buffer management section 10 for generating/managing the download buffers 71 to 7m is provided. Additionally, the upload buffer management section 9 or the download buffer management section 10 may be constituted by software.

An operation of a moving picture file distributing device (server) 1 according to the present embodiment will be described at first for the time of uploading. When the server 1 receives an upload request by a HTTP protocol from a file provider via a network I/F section 2, the HTTP server section 3 starts one HTTP upload session, and notifies a session number of an upload file to be received to the upload buffer management section 9. Here, the session corresponds to one file, and, for example, moving picture data for a certain period of time or moving picture data having a certain data size is included therein.

The upload buffer management section 9 generates an upload buffer in one-to-one correspondence with a notified session number in the buffer memory 8. Hereinafter, a description will be given assuming that the upload buffer 61 is generated. Subsequently, a reception of the upload file from the file provider is started, and the received file is temporarily held in the upload buffer 61 corresponding to the session number of the file.

When uploading one file is completed and the session is terminated, the file held in the upload buffer 61 is written into storage means 5 via the file I/O section 4 according to a file name designated at the time of upload request. Since the speed of this writing is remarkably faster than the channel transmission speed, a possibility that a download request occurs during this writing can be ignored so that writing the file is performed when the session is terminated. When writing the file into the storage means 5 is completed, the upload buffer management section 9 eliminates the upload buffer 61 used for holding the file.

When other upload requests are received during the above processing, the upload buffer 62 is similarly generated, and an upload file of the request is written into the storage means 5 via the same.

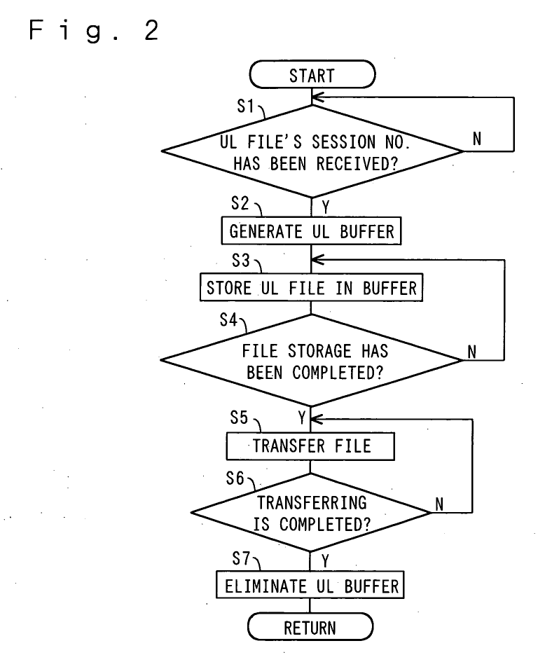

FIG. 2 is a flow chart showing one example of the operation of the upload buffer management section 9. At first, when a session number of an upload file is received from the HTTP server section 3 (S1), the upload buffer 61 is generated in the buffer 8 (S2), and subsequently a file to be received is stored in the generated upload buffer 61 (S3). When storing the entire file is completed (S4), the file is transferred to the storage means 5 (S5). When transferring the file to the storage means 5 is completed (S6), the upload file 61 is eliminated (S7), and the operation is terminated.

Next, an operation at the time of downloading will be described. When the server 1 receives a download request by the HTTP protocol from a client via the network I/F section 2, the HTTP server section 3 starts one HTTP download session, and notifies a file name and a session number of the download file to the download buffer management section 10.

The download buffer management section 10 generates a download buffer in one-to-one correspondence with a section number of the notified download file in the buffer memory 8. Hereinafter, a description will be given assuming that the download buffer 71 is generated. Subsequently, the file is read from the storage means 5 according to the file name of the notified download file and the file is transferred to the download buffer 71 of a corresponding session number via the file I/O section 4. Since the speed of reading the file from the storage means 5 is remarkably faster than the channel transmission speed, a possibility that an upload request occurs during this reading can be ignored.

The HTTP server section 3 starts to transfer a file in the download buffer 71 together with a response code of the download request. When transferring the file in the download buffer 71 is completed, the download session is terminated and the download buffer management session 10 eliminates the download buffer 71.

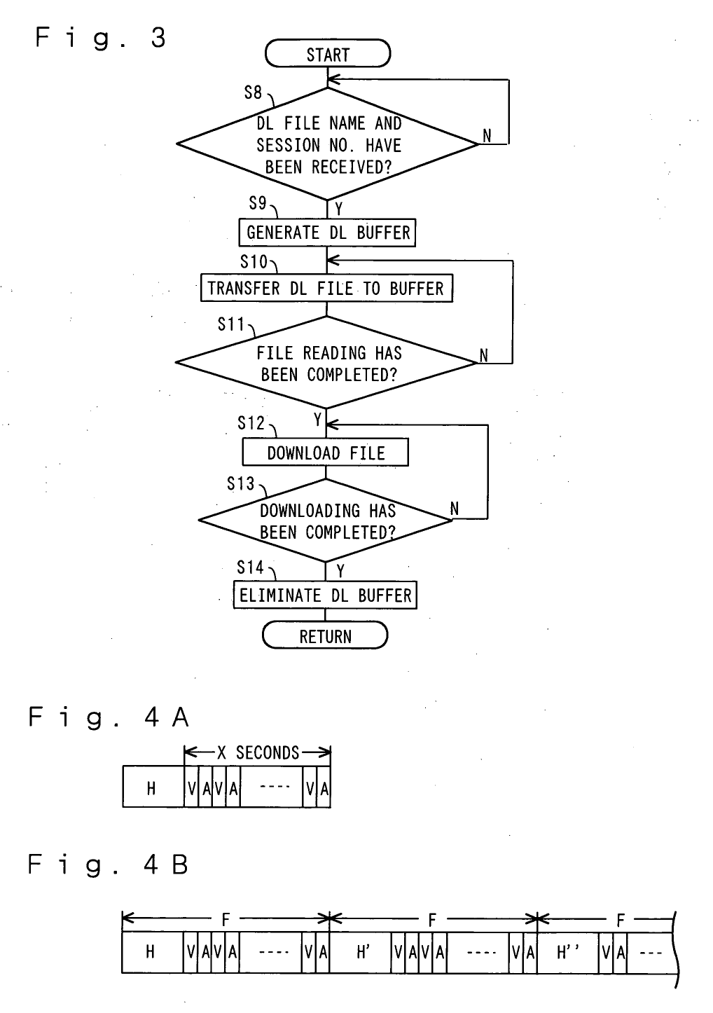

FIG. 3 is a flow chart showing one example of the operation of the download buffer management section 10. At first, when a file name and a session number of a download buffer file are received from the HTTP server section 3 (S8), the download buffer 71 is generated in the buffer 8 (S9), and subsequently the file is read from the storage means 5 according to the received file name (S10), and the file is stored in the download buffer 71. When reading the file is completed (S11), the file is downloaded to the client (S12). The downloading may be started before the completion of the file reading. When the downloading is completed (S13), the download file 71 is eliminated (S14), and the operation is terminated.

The HTTP server section 3 may receive a plurality of sessions for both uploading and downloading, and at this time, a session number is uniquely assigned to each session, and a buffer is generated. Further, a series of operations from the session starting and the buffer generating to the session terminating and the buffer eliminating can be simultaneously performed in the server 1 irrespective of uploading or downloading.

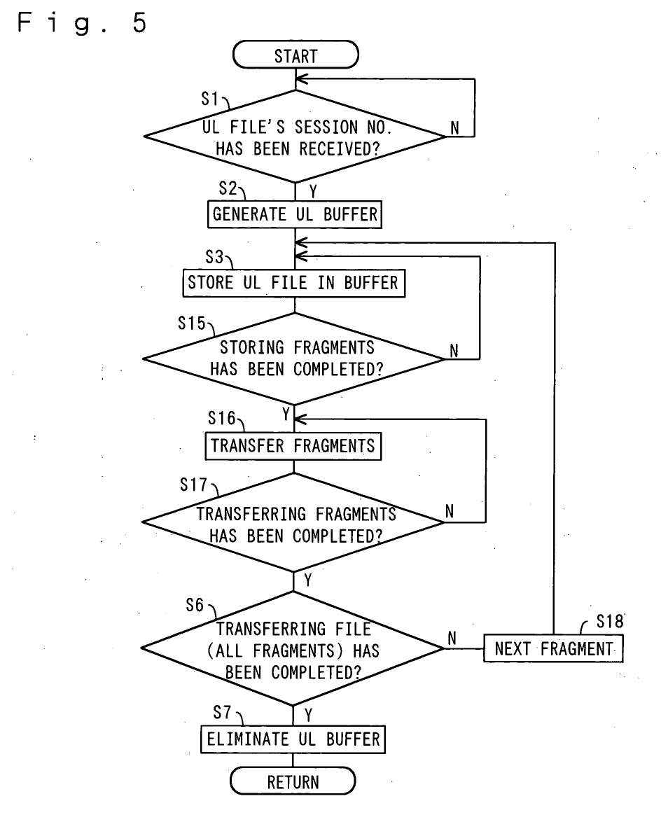

The present invention is not limited to a typical file structure composed of video data V and audio data A with one item of header information H as shown in FIG. 4A, and may be constituted to be adapted to a fragment structure where fragments F each composed of the video data V and the audio data A with one item of header information H are successive, as shown in FIG. 4B.

One block of V and A is called a chunk. In the case of FIG. 4A, specifically one chunk of V and A includes data for one second. Assuming a video frame rate of 10 fps and x=15 seconds, each file includes 15 pairs of V and A, and the number of video frames is 10 per one chunk.

The header information includes, for example, (1) time length of a file, (2) creation date/time of a file, (3) time length for each medium (V, A), (4) creation date/time of each medium, (5) size of V (height×width), (6) arrangement position of V chunk (byte offset), (7) total number of frames of V, (8) data size of one frame of V (number of bytes), (9) frame display duration of V, (10) encoding bit rate of V, (11) sampling frequency of A, (12) mode of A (monaural,stereo), (13) arrangement position of A chunk (byte offset), (14) data size of one frame of A, (15) frame reproduction duration of A, (16) total number of frames of A, and the like.

Further, in the case of FIG. 4B, the header information H of the first file header includes the above items (1) to (16) as in the case of FIG. 4A, but each of succeeding header information H′, H″, and so on, includes the above items (6) to (10) and (13) to (16).

As shown in FIG. 4B, when a moving picture file employs a division structure, that is, a fragment form therein, in the uploading of a moving picture file, an upload buffer may be generated when uploading is started, the fragment may be transferred to the storage means each time holding one fragment in the moving picture file in the upload buffer is completed, and the upload buffer may be eliminated when all the fragments in the moving picture file are transferred to the storage means.

Further, also in the downloading of a moving picture file, a download buffer may be generated when downloading is started, a moving picture file to be downloaded may be transferred from the storage means to the download buffer by one fragment, the fragment may be downloaded from the download buffer, and the download buffer may be eliminated when all the fragments in the moving picture file are downloaded.

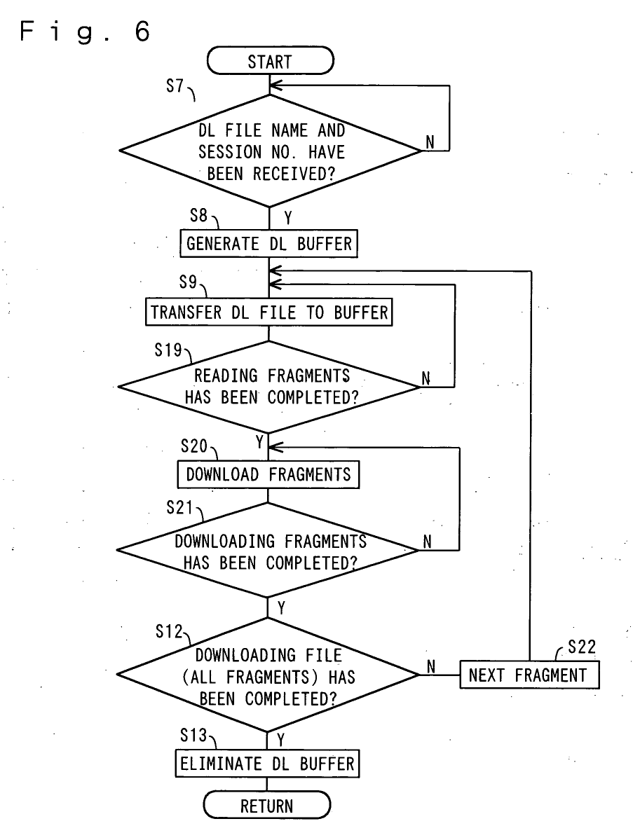

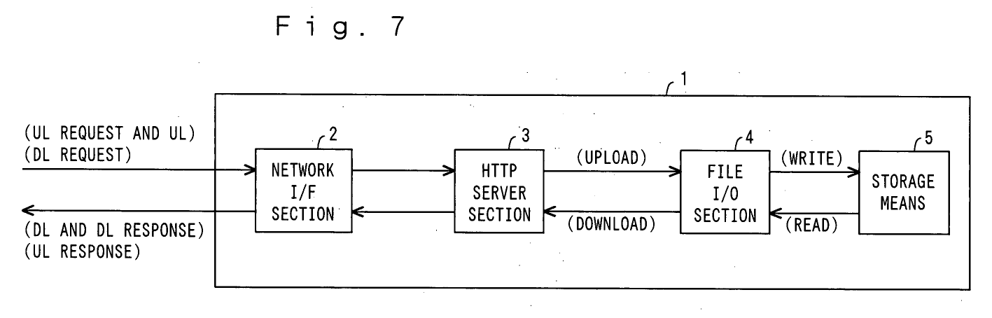

FIGS. 5 and 6 are flow charts showing the operations of the upload buffer management section 9 and the download buffer management section 10, respectively, when a moving picture file employs the fragment form. These are similar to FIGS. 2 and 3 and a detailed description thereof will be omitted, but these are different from FIGS. 2 and 3 in that transferring between the buffer and the storage means is performed for one fragment and eliminating a buffer is performed when transferring the entire file is completed (S15 to S18, S19 to S22).

Hereinbefore, a description is given to the embodiment, but various modifications may be performed without departing from the spirit of the present invention. For example, the moving picture file may not include the audio data A. Further, the storage means for storage of a moving picture file may employ various data storage means such as a virtual disk by a memory, not limited to a hard disk.

The moving picture file distributing device according to the present invention can be applied to a monitored video distributing server system for distributing a live image picked up by a monitoring camera to a mobile telephone or the Internet, and other moving picture distributing server systems.

As described above in detail, according to the present invention, an upload buffer for temporarily holding a received moving picture file is dynamically generated for each session and a download buffer for temporarily holding a moving picture file at the time of distribution is dynamically generated for each session. Therefore, even when a download request occurs during uploading, or even when an upload request occurs during downloading, a failure due to competition there between cannot occur, and the phenomena such as the unsuccessful uploading, the corruption of an upload file, the denial of downloading, or the corruption of a downloaded file can be prevented. Further, even when download requests are issued from a plurality of terminals, one download buffer is generated for each of the requests, so that the above phenomena can be prevented.

Furthermore, an upload buffer and a download buffer are dynamically generated/managed by providing the upload buffer management section and the download buffer management section so that a buffer can be effectively used to minimize the capacity thereof.

What is claimed is:

1. A moving picture file distributing device which receives a moving picture file by uploading and stores it in storage means, and distributes the moving picture file stored in the storage means to a client by downloading, comprising:
upload buffer generating means for dynamically generating an upload buffer for temporarily holding a moving picture file at the time of reception for each session; and
download buffer generating means for dynamically generating a download buffer for temporarily holding a moving picture file at the time of distribution for each session.

2. A moving picture file distributing device according to claim 1, comprising:
means for, after holding an entire moving picture file in the upload buffer is completed, transferring the moving picture file to the storage means; and
means for, after an entire moving picture file is transferred to the storage means, eliminating the upload buffer,
wherein the upload buffer generating means generates an upload buffer when uploading is started.

3. A moving picture file distributing device where a moving picture file has a fragment form according to claim 1, comprising:
means for, each time holding fragments in a moving picture file in the upload buffer by one fragment is completed, transferring the fragments to the storage means; and
means for, after all fragments in a moving picture file are transferred to the storage means, eliminating the upload buffer,
wherein the upload buffer generating means generates an upload buffer when uploading is started

4. A moving picture file distributing device according to claim 1, comprising:
means for, at the same time with the generation of the download buffer, transferring a moving picture file to be downloaded from the storage means to the download buffer; and
means for, after an entire moving picture file is downloaded, eliminating the download buffer,
wherein the download buffer generating means generates a download buffer when downloading is started.

5. A moving picture file distributing device where a moving picture file has a fragment form according to claim 1, comprising:
means for, at the same time with the generation of a download buffer, transferring a moving picture file to be downloaded from the storage means to the download buffer by one fragment; and
means for downloading fragments from the download buffer, and eliminating the download buffer after all fragments in a moving picture file are downloaded,
wherein the download buffer generating means generates a download buffer when downloading is started.
